(19) United States
(12) Patent Application Publication
(10) Pub. No.: US 2011/0134642 A1
(43) Pub. Date: Jun. 9, 2011

(54) LED SPOTLIGHT

(76) Inventor: Hor Lee, Hong Kong (CN)

(21) Appl. No.: 12/990,637

(22) PCT Filed: Apr. 27, 2009
(86) PCT No.: PCT/CN2009/071470

§ 371 Date: Nov. 1, 2010

(30) Foreign Application Priority Data
Apr. 30, 2008 (CN) 200820047249.8

(51) Int. Cl. F21S 4/00

(52) U.S. Cl. 362/249.06

(57) ABSTRACT

The LED spotlight relates to cold light source, and more particularly to a light-emitting device with a plurality of LEDs. The LED spotlight of the present Utility Model includes a plurality of LEDs and a circuit board, and the LEDs are installed on the circuit board, the LEDs are arranged in concentric circles with the shape of optical slits of Fresnel zone plate; the LEDs include spherical tops.

### FIELD OF THE UTILITY MODEL

The present Utility Model relates to cold light source, and more particularly to a light-emitting device with a plurality of LEDs (light-emitting diodes).

### DESCRIPTION OF THE RELATED ART

In the prior art regarding LED lighting, common methods to enhance illumination of the lighting include using a large number of LED units that are arranged in a high density, or using a reflector. These methods can increase the cost of the lighting. Therefore, there is an urgent need to produce a high illumination with fewer LED units.

### SUMMARY OF THE UTILITY MODEL

One object of the present Utility Model is to provide a LED spotlight that overcomes the above-mentioned problems in the field of LED lighting. In the LED spotlight, the LED units are arranged such that the LED spotlight can generate a lighting with an enhanced illumination.

The LED spotlight of the present Utility Model includes a plurality of LEDs (light-emitting diodes) and a circuit board. The LEDs are installed on the circuit board. The LEDs are arranged in concentric circles with the shape of optical slits of a Fresnel zone plate; more preferably, the LEDs include spherical tops; and the LEDs are driven by DC (direct current).

In the LED spotlight of the present Utility Model, the LEDs are arranged into several concentric circles according to the shape and dimension of the optical slits of the Fresnel zone plate, and each concentric circle functions as a secondary wave-emitting unit; such an arrangement can simulates a diffraction field of the Fresnel zone plate so that the light beams converge several times along the projection path; and thereby producing light beams of a high luminance.

### BRIEF DESCRIPTION OF THE DRAWINGS

FIG. 1 is a perspective view of an exemplary LED spotlight according to a first embodiment of the present Utility Model;

FIG. 2 is an exemplary diagram of a diffraction field of the Fresnel zone plate;

FIG. 3 is a front view of the LED spotlight illustrating an exemplary arrangement of the LEDs according to a second embodiment;

FIG. 4 is a front view of the LED spotlight illustrating an exemplary arrangement of the LEDs according to a third embodiment.

### DETAILED DESCRIPTION OF THE EXEMPLARY EMBODIMENTS

Detailed description of the present Utility Model is made as follows in combination with the accompanying drawings and the preferred embodiments.

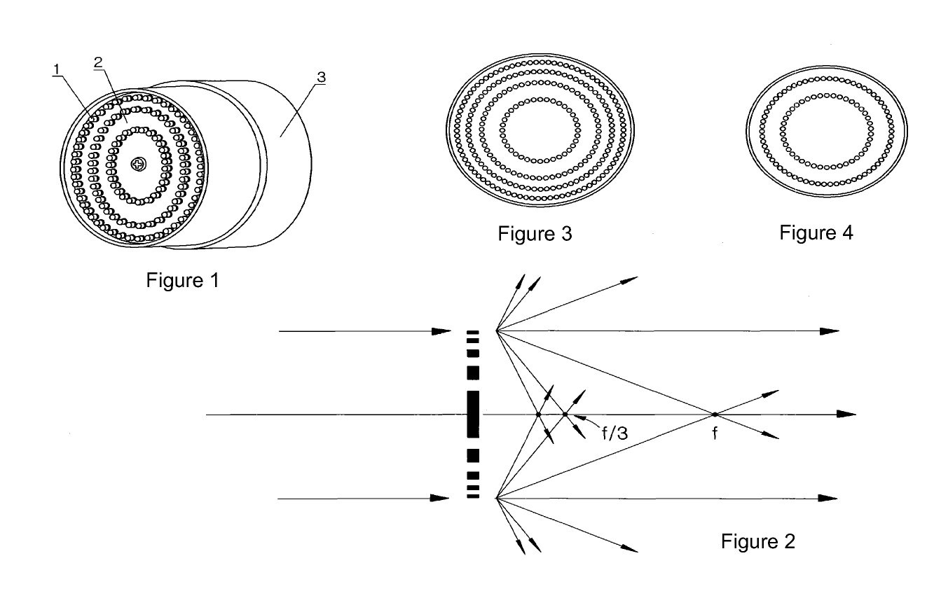

As shown in FIG. 1, the LED Spotlight in a first embodiment has 116 white LEDs 1 with spherical tops. The LEDs are arranged according to the shape and dimension of the optical slits of the Fresnel zone plate, and are all driven to emit light by a DC power supply. The LEDs 1 are arranged into three concentric circles, and are vertically welded on circuit board 2, and the circuit board 2 is fixed on case 3. The three concentric circles simulate three concentric circular optical slits of a Fresnel zone plate. The light beams from the LEDs arranged in the concentric circles with different diameters converge along the projection path forward, and produce a spot with a high luminance in the center of the beams.

As shown in FIG. 2, parallel monochromatic light beams strike the Fresnel zone plate from the left side, and diffract after they pass through the optical slits of the Fresnel zone plate.

As shown in FIG. 3, in a second embodiment, the LEDs are arranged in four concentric circles that simulate four optical slits of the Fresnel zone plate, and the diameters of the four circles are 83 mm, 102 mm, 117 mm and 130 mm, respectively.

As shown in FIG. 4, in a third embodiment, the LEDs are arranged in two concentric circles that simulate two optical slits of the Fresnel zone plate. Such an arrangement can also achieve the purpose that in the center of the light generated by the LED spotlight there is no dark zone and the luminance is enhanced.

The LED spotlight of the present Utility Model has several advantages including its capacity to generate a high illumination, and its simple structure and low cost. It is suitable for use in the occasions that need an intense light source.

What is claimed is:

1. A LED spotlight comprising: LEDs (1) and a circuit board (2), the LEDs (1) being installed on the circuit board (2), wherein the LEDs are arranged in concentric circles with the shape of optical slits of a Fresnel zone plate.

2. The LED spotlight according to claim 1, wherein said LEDs comprise spherical tops.
